(19) United States
(12) Patent Application Publication
(10) Pub. No.: US 2026/0099574 A1
(43) Pub. Date: Apr. 9, 2026

(54) HOST, SECURE LOGIN SYSTEM, AND SECURE LOGIN METHOD

(71) Applicant: HTC Corporation, Taoyuan City (TW)

(72) Inventors: Yu Heng Hong, Taoyuan City (TW); Jia-Yau Shiau, Taoyuan City (TW)

(73) Assignee: HTC Corporation, Taoyuan City (TW)

(21) Appl. No.: 18/908,791

(22) Filed: Oct. 8, 2024

(51) Int. Cl. G06F 21/32; G06F 3/01; G06F 3/04815; G06F 3/0486

(52) U.S. Cl. CPC G06F 21/32; G06F 3/017; G06F 3/04815; G06F 3/0486

(57) ABSTRACT

A host, a secure login system, and a secure login method are described herein. The host includes a storage circuit and a processor. The storage circuit is configured to store a program code. The processor is coupled to the storage circuit and configured to access the program code to execute: in response to a login request, encoding a plurality of key characters into a plurality of key gestures to determine a key relationship between the plurality of key characters and the plurality of key gestures; displaying at least part of the plurality of key characters in a virtual world based on the key relationship; obtaining a gesture sequence of a plurality of input gestures of a user; decoding the gesture sequence into an input sequence based on the key relationship; and outputting the input sequence for the login request.

### BACKGROUND

### Technical Field

The disclosure relates to a host; particularly, the disclosure relates to a host, a secure login system, and a secure login method.

### Description of Related Art

In order to bring an immersive experience to user, technologies related to extended reality (XR), such as augmented reality (AR), virtual reality (VR), and mixed reality (MR) are constantly being developed. AR technology allows a user to bring virtual elements to the real world. VR technology allows a user to enter a whole new virtual world to experience a different life. MR technology merges the real world and the virtual world. Further, to bring a fully immersive experience to the user, visual content, audio content, or contents of other senses may be provided through one or more devices.

### SUMMARY

The disclosure is direct to a host, a secure login system, and a secure login method, so as to provide a safer way for the user to enter confidential data.

The embodiments of the disclosure provide a host. The host includes a storage circuit and a processor. The storage circuit is configured to store a program code. The processor is coupled to the storage circuit and configured to access the program code to execute: in response to a login request, encoding a plurality of key characters into a plurality of key gestures to determine a key relationship between the plurality of key characters and the plurality of key gestures; displaying at least part of the plurality of key characters in a virtual world based on the key relationship; obtaining a gesture sequence of a plurality of input gestures of a user; decoding the gesture sequence into an input sequence based on the key relationship; and outputting the input sequence for the login request.

The embodiments of the disclosure provide a secure login system. The secure login system includes a private display device, a storage circuit, and a processor. The private display device is configured to display virtual content and the virtual content is only visible to a user. The storage circuit is configured to store a program code. The processor is coupled to the storage circuit and configured to access the program code to execute: in response to a login request, encoding a plurality of key characters into a plurality of key gestures to determine a key relationship between the plurality of key characters and the plurality of key gestures; displaying at least part of the plurality of key characters in a virtual world based on the key relationship; obtaining a gesture sequence of a plurality of input gestures of a user; decoding the gesture sequence into an input sequence based on the key relationship; and outputting the input sequence for the login request.

The embodiments of the disclosure provide a secure login method. The secure login method includes: in response to a login request, encoding, through a processor, a plurality of key characters into a plurality of key gestures to determine a key relationship between the plurality of key characters and the plurality of key gestures; displaying, through a private display device, at least part of the plurality of key characters in a virtual world based on the key relationship; obtaining, through a sensor, a gesture sequence of a plurality of input gestures of a user; decoding, through a processor, the gesture sequence into an input sequence based on the key relationship; and outputting, through a processor, the input sequence for the login request.

Based on the above, according to the host, the secure login system, and the secure login method, even if people nearby see movements of the hand of the user, they are still not able to obtain clues to the content being inputting by the user. Therefore, the user may enter confidential data conveniently and safely, thereby increasing the user experience.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of a host according to an embodiment of the disclosure.

FIG. 1B is a schematic diagram of a secure login system according to an embodiment of the disclosure.

FIG. 2A to FIG. 2C are some schematic diagrams of a secure login scenario according to an embodiment of the disclosure.

FIG. 3A to FIG. 3D are some schematic diagrams of some secure login scenarios according to some embodiments of the disclosure.

FIG. 4A to FIG. 4C are some schematic diagrams of a secure login scenario according to an embodiment of the disclosure.

FIG. 5 is a schematic diagram of a secure login scenario according to an embodiment of the disclosure.

FIG. 6 is a schematic diagram of a secure login scenario according to an embodiment of the disclosure.

FIG. 7 is a schematic flowchart of a secure login method according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In today's digital age, personalized services have become ubiquitous across various digital applications. Usually, users are asked to create accounts in order to access exclusive features and content. This process typically involves providing a unique username or email address, along with a password that serves as a security measure to protect the user's identity and information.

While traditional account creation and login methods have become ingrained in our digital habits, they raise concerns regarding privacy and security. It is noted that, the standard approach of entering credentials relying on a well-known fixed layout (e.g., the layout on a keyboard), even on devices with private display devices (e.g., head-mounted devices). This may potentially expose sensitive information to onlookers. That is, through observing hand movements and keystroke patterns, other people may obtain clues to password combinations, thereby compromising the user's security. Therefore, it is the pursuit of people skilled in the art to provide a safer way for the user to enter confidential data.

In order to solve this issue, a new method is proposed herein. Instead of relying on a fixed layout, a random layout may be provided each time when a user intends to login. The random layout may include a plurality of gestures and a plurality of characters corresponding to the plurality of gestures. Further, since the user is using a private display device, the random layout may be only visible to the user. In this manner, even if people nearby see movements of the hand of the user, they are still not able to obtain clues to the content being inputting by the user. Therefore, the user may enter confidential data conveniently and safely, thereby increasing the user experience.

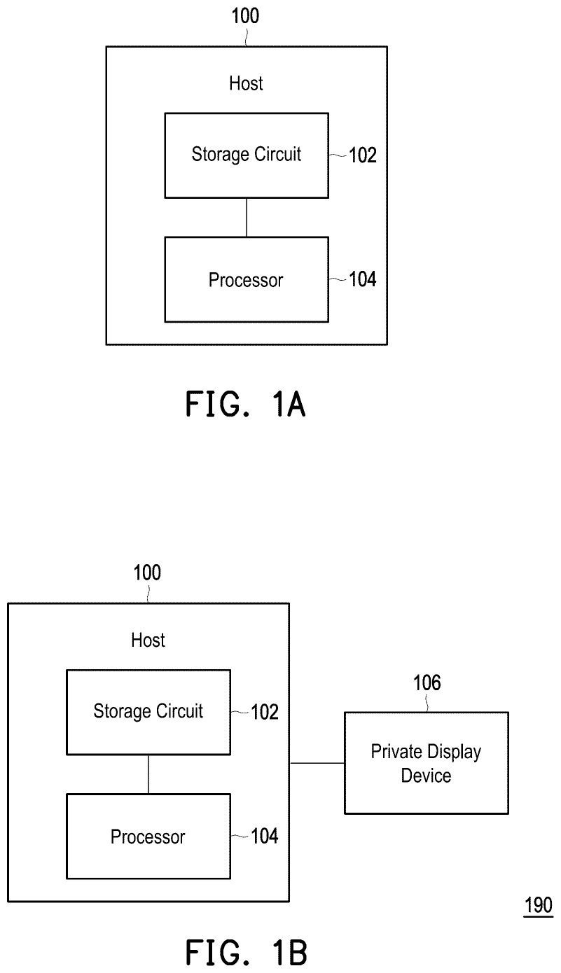

FIG. 1A is a schematic diagram of a host according to an embodiment of the disclosure. In various embodiments, a host 100 may be any smart device and/or computer device. In some embodiments, the host 100 may be any electronic device capable of providing reality services (e.g., AR/VR/MR services, or the like). In some embodiments, the host 100 may be implemented as an XR device, such as a pair of AR/VR glasses and/or a head-mounted device. In some embodiments, the host 100 may be a computer and/or a server, and the host 100 may provide the computed results (e.g., AR/VR/MR contents) to other external display device(s), such that the external display device(s) can show the computed results to the user. However, this disclosure is not limited thereto.

In FIG. 1A, the host 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules and/or a program code that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 104 may access the modules and/or the program code stored in the storage circuit 102 to implement a secure login method provided in the disclosure, which would be further discussed in the following.

FIG. 1B is a schematic diagram of a secure login system according to an embodiment of the disclosure. A secure login system 190 may include the host 100 and a private display device 106. Details of the host 100 may be referred to the description of FIG. 1A, while the details are not redundantly described seriatim herein.

The private display device 106 may include a display device of an XR device, such as a pair of AR/VR glasses or a head-mounted device. Content displayed by the private display device 106 may be only visible to a user. That is, onlookers are not able to see the content displayed by the private display device 106. In one embodiment, the private display device 106 may include, for example, an organic light-emitting diode (OLED) display device, a mini LED display device, a micro LED display device, a quantum dot (QD) LED display device, a liquid-crystal display (LCD) display device, a tiled display device, a foldable display device, or an electronic paper display (EPD). However, the disclosure is not limited thereto.

In some embodiments, the secure logic system 190 may further include or communicate with a sensor. The sensor may be, for example, a complementary metal oxide semiconductor (CMOS) camera, a charge coupled device (CCD) camera, a light detection and ranging (LiDAR) device, a radar, an infrared sensor, an ultrasonic sensor, other similar devices, or a combination of these devices. In some embodiments, the sensor may be disposed on an head-mounted device, wearable glasses (e.g., AR/VR goggles), an electronic device, other similar devices, or a combination of these devices. However, this disclosure is not limited thereto. In the embodiments of the disclosure, the sensor may be used to capture user images of the user and the processor 104 may be configured to perform hand tracking of hand of the user based on the user images. However, the disclosure is not limited thereto.

In some embodiments, the host 100 and/or the private display device 106 may further include a communication circuit. The communication circuit may include, for example, a wired network module, a wireless network module, a Bluetooth module, an infrared module, a radio frequency identification (RFID) module, a Zigbee network module, or a near field communication (NFC) network module, but the disclosure is not limited thereto. That is, the host 100 and the private display device 106 may communicate with each other or with external device(s) (such as the sensor . . . etc.) through either wired communication or wireless communication.

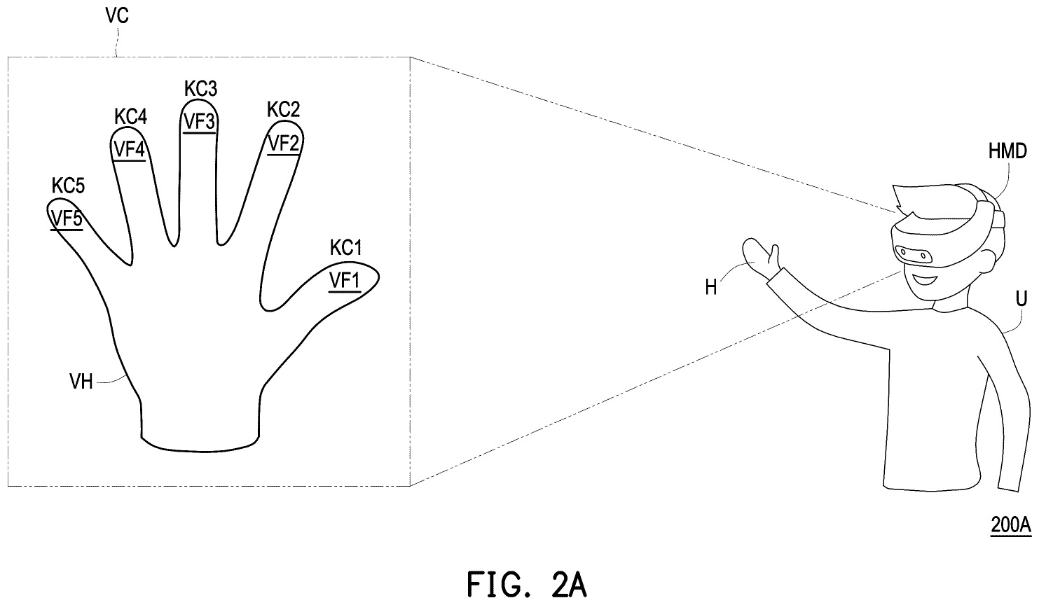

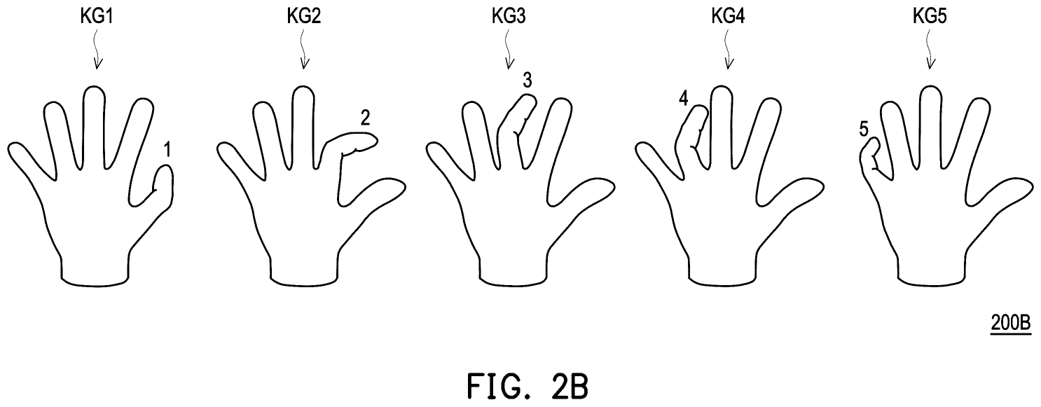

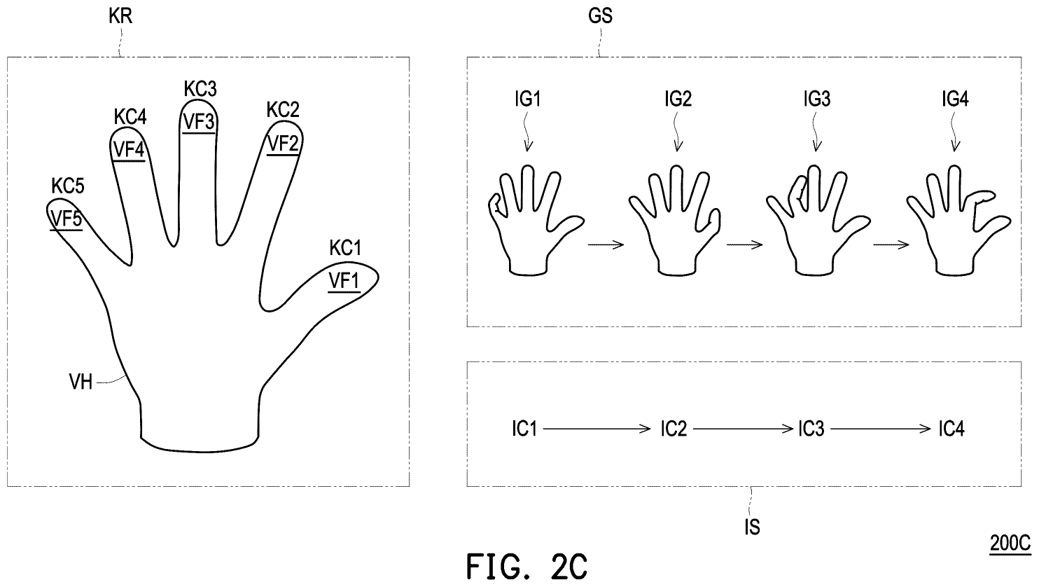

FIG. 2A to FIG. 2C are some schematic diagrams of a secure login scenario according to an embodiment of the disclosure.

Reference is first made to FIG. 2A. A secure login scenario 200A may include a user U, a hand H, a head-mounted device HMD, a virtual content VC, a virtual hand VH, a plurality of virtual fingers VF1˜VF5, and a plurality of key characters KC1˜KC5. It is noted that, for the sake of convenience in explanation, the hand H, fingers of the hand H, the virtual hand VH, and the virtual fingers VF1˜VF5 may be described separately herein. However, the virtual hand VH and the virtual fingers VF1˜VF5 may be a passthrough realtime image. For example, in an AR environment, while the user U is wearing AR glasses, the hand H and the fingers of the hand H saw by the user U may be considered as the virtual hand H and the virtual fingers VF1˜VF5. That is to say, this disclosure does not limit that the virtual hand VH and the virtual fingers VF1˜VF5 are virtual objects displayed by a display or real objects captured by the user through an XR device.

In the secure login scenario 200A, the user U may be immersed in a virtual experience through the head-mounted device HMD. For example, the user U may wear the head-mounted device HMD. The head-mounted device HMD may include a private display device 106, showing the virtual content VC in a virtual world that is only visible to the user U. In one embodiment, the virtual content VC may only include the plurality of key characters KC1˜KC5. In another embodiment, the virtual content VC may further include the virtual hand VH with the plurality of virtual fingers VF1˜VF5. In addition, the head-mounted device HMD may include a sensor to detect movements of a (physical) hand H of the user U, thereby making the virtual experience more interactive and intuitive.

In one embodiment, in the virtual content VC, the plurality of key characters KC1˜KC5 may be shown to the user U. Further, each of the plurality of key characters KC1˜KC5 may correspond to one of the plurality of virtual fingers VF1˜VF5. For example, the plurality of key characters KC1˜KC5 may be randomly assigned to the plurality of virtual fingers VF1˜VF5. However, this disclosure is not limited thereto. In another embodiment, in the AR environment, AR glasses may capture the image of the hand H and then overlay the key characters KC1˜KC5 directly onto the fingers of the hand H. This allows for a more intuitive and natural interaction with the virtual environment, as the user U may interact with virtual objects using the hand H in the real world. However, this disclosure is not limited thereto.

By moving a physical finger corresponding to one of the plurality of virtual fingers VF1˜VF5, a corresponding one of the plurality of key characters KC1˜KC5 may be triggered and input into the secure login system 190. For example, the user U may perform a click movement with a physic index finger. Since the physic index finger corresponds to the virtual finger VF2, the key character KC2 may be input into the secure login system 190. It is noted that, the click movement of the physical finger of the hand H may be defined as a “key gesture”. That is, in response to the key gesture is detected, the secure login system 190 may be configured to input one of the plurality of key characters KC1˜KC5.

In other words, the plurality of key characters KC1˜KC5 may be encoded into the plurality of key gestures to determine a key relationship between the plurality of key characters KC1˜KC5 and the plurality of key gestures. In one embodiment, the plurality of key characters KC1˜KC5 may be encoded into the plurality of key gestures by randomly assigning the plurality of key characters KC1˜KC5 to the plurality of key gestures. Further, the plurality of key characters KC1˜KC5 may be encoded in response to a login request. However, this disclosure is not limited thereto. By displaying the plurality of key characters KC1˜KC5 and/or the plurality of key gestures based on the key relationship to the user U, the user U may understand how to input a specific character by performing a specific gesture.

For example, as shown in the FIG. 2A, the plurality of key characters KC1˜KC5 displaying near the plurality of virtual fingers VF1˜VF5 may indicate the key relationship. That is, by viewing the virtual content VC, the user U may know that performing the plurality of key gestures (e.g., performing the click movement with the plurality of virtual fingers VF1˜VF5) may trigger the input of the plurality of key characters KC1˜KC5.

Reference is now made to FIG. 2B. A secure login scenario 200B may include a plurality of key gestures KG1˜KG5. For purposes of simplicity, some of the reference signs are not shown in FIG. 2B, which may be referred to FIG. 2A for details.

In one embodiment, the plurality of key gestures KG1˜KG5 may be shown in the virtual content VC. Each of the plurality of key gestures KG1˜KG5 shows that a back of the virtual hand VH and the plurality of virtual fingers VF1˜VF5, wherein one of the virtual finger is performing a click movement (i.e., shown as a bent finger). That is, instead of showing one virtual hand VH implying the plurality of key gestures KG1˜KG5, the plurality of key gestures KG1˜KG5 may be shown directly in the virtual content VC. However, this disclosure is not limited thereto.

Reference is then made to FIG. 2C. A secure login scenario 200C may include a key relationship KR, a gesture sequence GS, and an input sequence IS.

In one embodiment, the key relationship KR shows a relationship between the plurality of key characters KC1˜KC5 and the plurality of key gestures KG1˜KG5. As mentioned above, the plurality of key gestures KG1˜KG5 may be represented by placing the plurality of key characters KC1˜KC5 near the plurality of virtual fingers VF1˜VF5. By displaying the key relationship KR in the virtual content VC, the user U may understand how to input a specific character by performing a specific gesture.

Then, the processor 104 may be configured to perform a hand tracking through the sensor of the head-mounted device HMD. Based on the hand tracking, the processor 104 may be configured to obtain the gesture sequence GS of the plurality of input gestures IG1˜IG4 of the user U. That is, the user U may perform the input gestures IG1˜IG4 in sequence and the sequence is defined as the gesture sequence GS. The input gestures IG1˜IG4 may be an encoding result of a password of the user U that is encoded based on the key relationship KR.

In other words, in order to input the password, the user U may perform some of the plurality of key gestures KG1˜KG5 in a specific order and the performed gestures will be determined as the input gestures IG1˜IG4 based on the hand tracking. However, this disclosure is not limited thereto.

Next, the processor 104 may be configured to decode the gesture sequence GS into the input sequence IS based on the key relationship KR. Specifically, the processor 104 may be configured to decode the gesture sequence GS by decoding each of the input gestures IG1˜IG4 of the gesture sequence GS into one of the plurality of key characters KC1˜KC4 based on the key relationship KR.

For example, as shown FIG. 2C, the gesture sequence GS may include four gestures, which are respectively a hand with bent pinky, a hand with bent thumb, a hand with a bent ring finger, and a hand with a bent index finger. Based on the key relationship KR, the hand with bent pinky, the hand with bent thumb, the hand with the bent ring finger, and the hand with the bent index finger may respectively represent the key character KC5, the key character KC1, the key character KC4, and the key character KC2 in sequence.

That is, a decoding result of the gesture sequence GS may be the key character KC5, the key character KC1, the key character KC4, and the key character KC2 in sequence and these characters may be respectively determined as a plurality of input characters IC1˜IC4. In other words, the input sequence IS may include the plurality of input characters IC1˜IC4. However, this disclosure is not limited thereto.

In addition, the processor 104 may be configured to perform a comparison of the input sequence IS with a password sequence. In one embodiment, the password sequence may be a password that is predetermined by the user U and includes a plurality of characters. Further, the processor 104 may be configured to determining a login result of the login request based on the comparison. For example, if the input sequence IS is same as the password sequence, the login result may be determined as “success”. On the other hand, if the input sequence IS is not same as the password sequence, the login result may be determined as “fail”. However, this disclosure is not limited thereto.

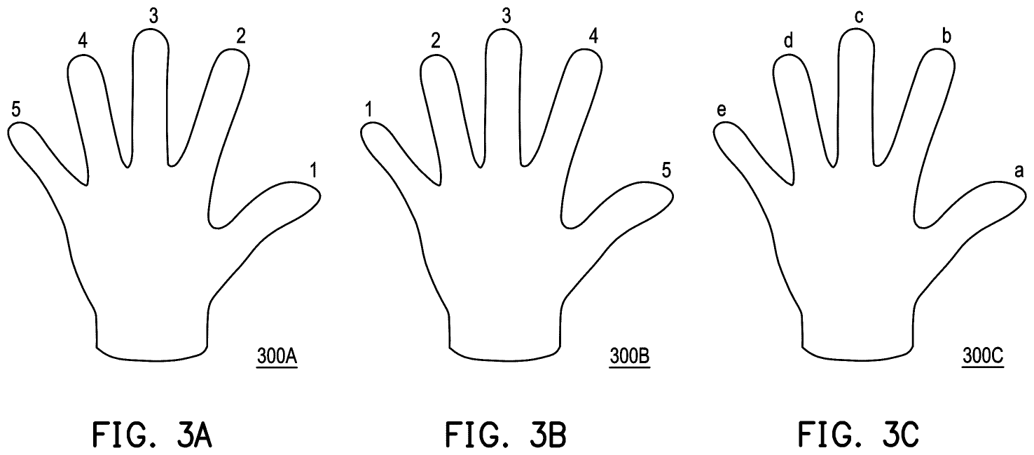

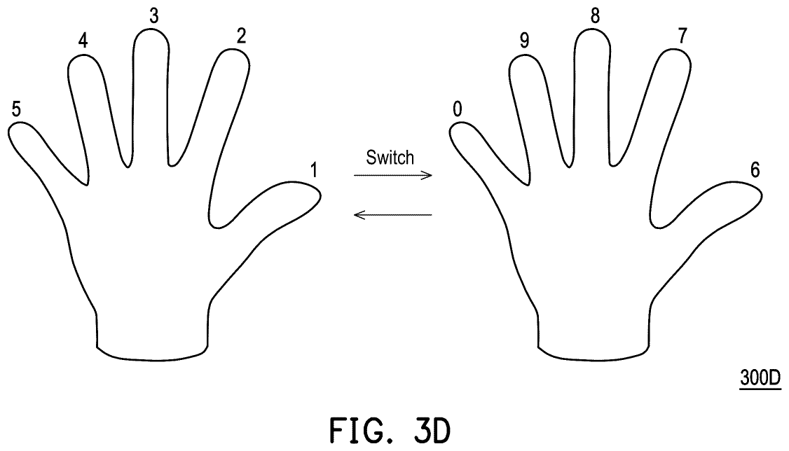

FIG. 3A to FIG. 3D are some schematic diagrams of some secure login scenarios according to some embodiments of the disclosure. For purposes of simplicity, some of the reference signs are not shown in FIG. 3A to FIG. 3D, which may be referred to FIG. 2A for details.

Reference is first made to FIG. 3A. In a secure login scenario 300A, five numbers are respectively shown near the virtual fingers VF1˜VF5 (i.e., thumb to pinky). Specifically, “1” is shown near the thumb, “2” is shown near the index finger, “3” is shown near the middle finger, “4” is shown near the ring finger, and “5” is shown near the pinky. That is, by performing a click movement with the virtual fingers VF1˜VF5, one of the five numbers will be input. For example, if the user U performs the click movement with the index finger, “2” will be input. However, this disclosure is not limited thereto.

Reference is now made to FIG. 3B. In a secure login scenario 300B, five numbers are respectively shown near the virtual fingers VF1˜VF5 (i.e., thumb to pinky). Compared with the secure login scenario 300A, the difference is that the five number are assigned to the five virtual fingers VF1˜VF5 reversely. That is, “5” is shown near the thumb, “4” is shown near the index finger, “3” is shown near the middle finger, “2” is shown near the ring finger, and “1” is shown near the pinky. That is, by performing a click movement with the virtual fingers VF1˜VF5, one of the five numbers will be input. For example, if the user U performs the click movement with the index finger, “4”will be input. However, this disclosure is not limited thereto.

Reference is now made to FIG. 3C. In a secure login scenario 300C, five alphabets are respectively shown near the virtual fingers VF1˜VF5 (i.e., thumb to pinky). Specifically, “a” is shown near the thumb, “b” is shown near the index finger, “c” is shown near the middle finger, “d” is shown near the ring finger, and “e” is shown near the pinky. That is, by performing a click movement with the virtual fingers VF1˜VF5, one of the five alphabets will be input. For example, if the user U performs the click movement with the index finger, “b” will be input. However, this disclosure is not limited thereto.

It is noted that, in one embodiment, referring to FIG. 3A and FIG. 3B, the five numbers are shown near the virtual fingers VF1˜VF5. That is, the key characters KC1˜KC5 may include numbers. In another embodiment, referring to FIG. 3C, the five alphabets are shown near the virtual fingers VF1˜VF5. That is, the key characters KC1˜KC5 may include alphabets. In yet another embodiment, according to design needs, the key characters KC1˜KC5 may include alphabets and/or numbers. However, this disclosure is not limited thereto.

Reference is now made to FIG. 3D. A secure login scenario 300D may include two virtual hands VH. Each of the virtual hands VH is shown with a set of five numbers. Specifically, the virtual hand VH on the left-hand side is shown with a first set of numbers (e.g., 1˜5) and the virtual hand VH on the right-hand side is shown with a second set of numbers (e.g., 6˜0). For purposes of simplicity, some of the reference signs are not shown in FIG. 3D, which may be referred to FIG. 2A for details.

In one embodiment, only one of the two virtual hands VH may be shown in the virtual content VC. Further, a switch gesture may be used to switch the display virtual hand VH to another virtual hand VH. In one embodiment, the switch gesture may be flipping the palm/wrist, a movement/interaction with multiple fingers on one hand or both hands, or making a fist and releasing it. However, this disclosure is not limited thereto. That is, the processor 104 may be configured to determine that whether one of the plurality of input gestures IG1˜IG4 being the switch gesture. Then, in response to the plurality of input gestures IG1˜IG4 being the switch gesture, the processor 104 may be configured to display a plurality of switched key characters (e.g., 6˜0 instead of 1˜5) and/or a plurality of switched key gestures in the virtual world based on the key relationship KR.

In this manner, the user U is able to input more than five characters using only one hand, thereby increasing the user experience.

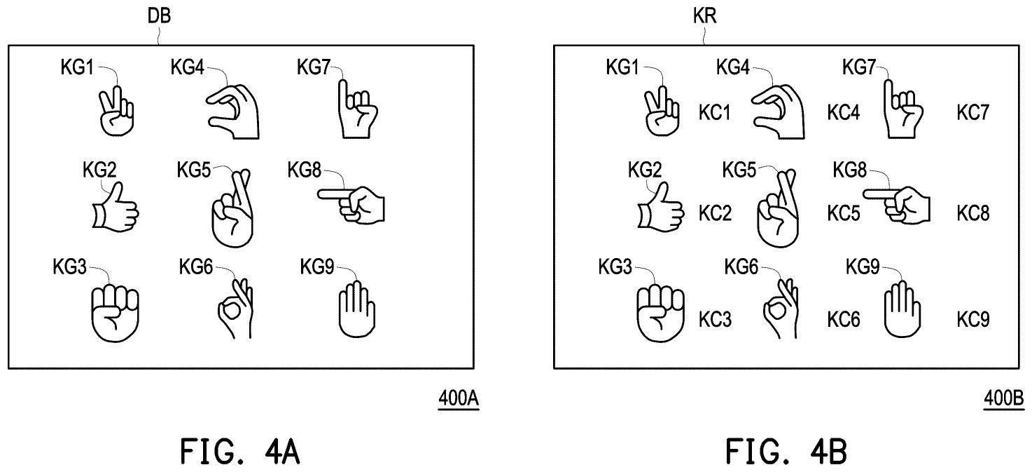

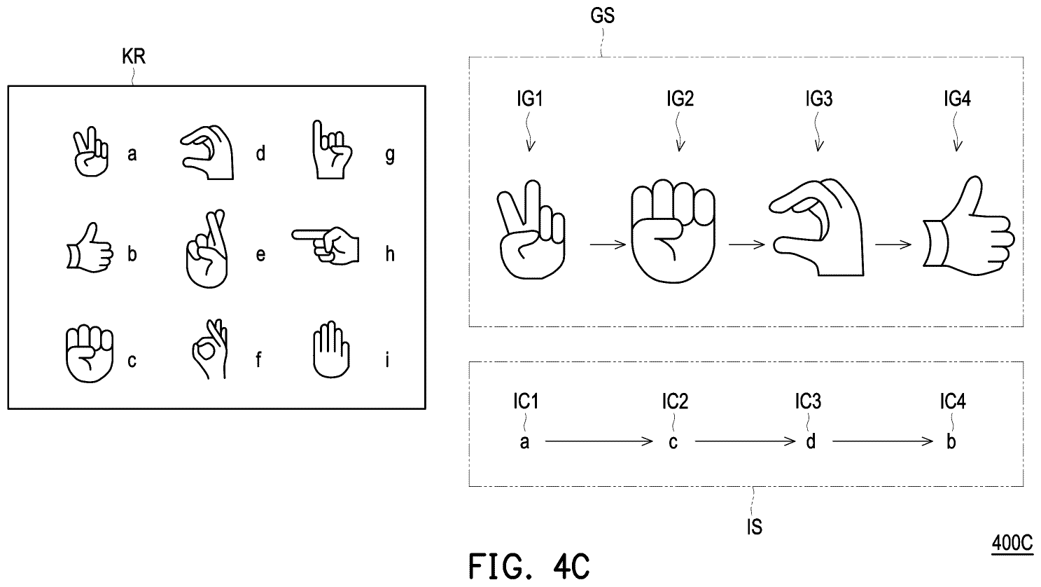

FIG. 4A to FIG. 4C are some schematic diagrams of a secure login scenario according to an embodiment of the disclosure.

Reference is first made to FIG. 4A. A secure login scenario 400A may include a gesture database DB. The gesture database DB may include a plurality of key gestures KG1˜KG9 and the plurality of key gestures KG1˜KG9 may be predetermined by the user U. That is, the processor 104 may be configured to obtain a plurality of self-defined gestures of the user U. Then, the processor 104 may be configured to determine the plurality of self-defined gestures as the plurality of key gestures KG1˜KG9. Therefore, instead of utilizing some default gestures provided by the secure login system 190 as the plurality of key gestures KG1˜KG9, the plurality of key gestures KG1˜KG9 may be determined according to a preference or a habit of the user U, thereby improving the user experience.

Reference is now made to FIG. 4B. A secure login scenario 400B may include the key relationship KR. Similar as FIG. 2C, the key relationship KR may include the plurality of key gestures KG1˜KG9 of the gesture database DB and a plurality of key characters KC1˜KC9. In one embodiment, the plurality of key characters KC1˜KC9 may be randomly assigned to the plurality of key gestures KG1˜KG9. Therefore, the user U may be able to perform gestures for inputting the characters according to a preference or a habit of the user U, thereby improving the user experience.

Reference is then made to FIG. 4C. Similar as FIG. 2C, a secure login scenario 400C may include the key relationship KR, the gesture sequence GS, and the input sequence IS. For purposes of simplicity, some of the reference signs are not shown in FIG. 4C, which may be referred to FIG. 4B for details.

In one embodiment, the plurality of key characters KC1˜KC9 may be the alphabets a˜i. Further, the key relationship KR shows a relationship between the plurality of key characters KC1˜KC9 and the plurality of key gestures KG1˜KG9. By displaying the key relationship KR in the virtual content VC, the user U may understand how to input a specific character by performing a specific gesture.

Then, in order to complete a login operation, the user U may perform some of the plurality of key gestures KG1˜KG9 in a specific order. That is, the gestures performed by the user U may be a encoding result of a password of the user U that is encoded based on the key relationship KR. Further, the gestures performed by the user U may be obtained based on the hand tracking and will be determined as the gesture sequence GS of the input gestures IG1˜IG4.

Next, the processor 104 may be configured to decode the gesture sequence GS into the input sequence IS based on the key relationship KR. Specifically, each of the gesture sequence GS may be one by one decoded into one of the plurality of key characters KC1˜KC9. These decoded characters may be determined as the input characters IC1˜IC4, respectively. That is, the gesture sequence GS of the input gestures IG1˜IG4 may be decoded into the input sequence IS of the input characters IC1˜IC4.

In this manner, the user U may be able to perform gestures for inputting the characters according to a preference or a habit of the user U. Therefore, the user U may enter confidential data conveniently and safely, thereby increasing the user experience.

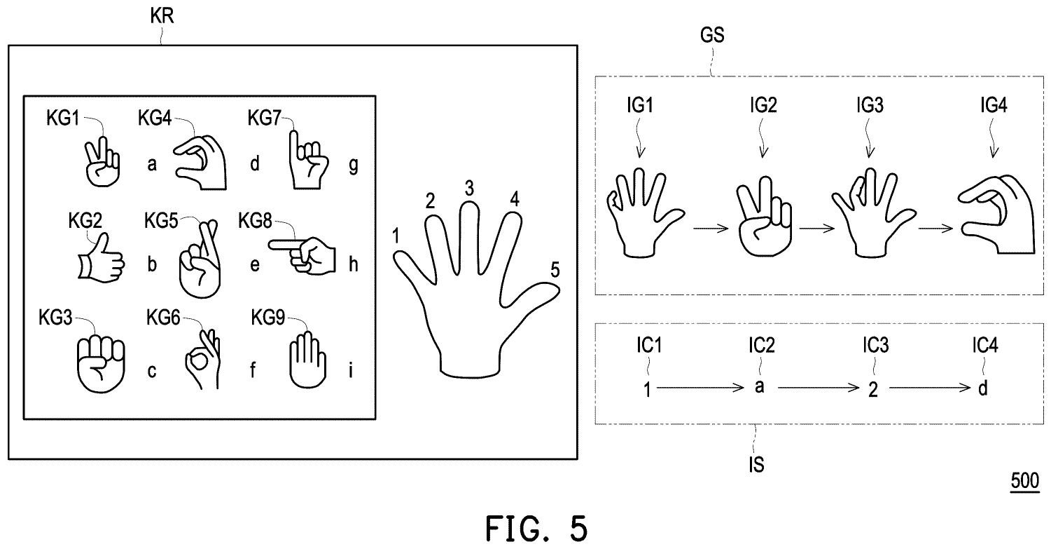

FIG. 5 is a schematic diagram of a secure login scenario according to an embodiment of the disclosure. Referring to FIG. 5, a secure login scenario 500 is a combination of the secure login scenario 200C and the secure login scenario 400C. That is, the key relationship KR may not only include a relationship between the key gestures KG1˜KG9 of the gesture database DB and the plurality of key characters KC1˜KC9, but also include a relationship between the gestures of performing the click movement with one of the virtual fingers VF1˜VF5. That is, the secure login system 190 may provide more options for the user U to set up the password or input the password, thereby improving the user experience.

In one embodiment, the key gestures KG1˜KG9 of the gesture database DB may be configured to represent a plurality of alphabets. Further, the gestures of performing the click movement with one of the virtual fingers VF1˜VF5 may be configured to represent a plurality of numbers. However, this disclosure is not limited thereto.

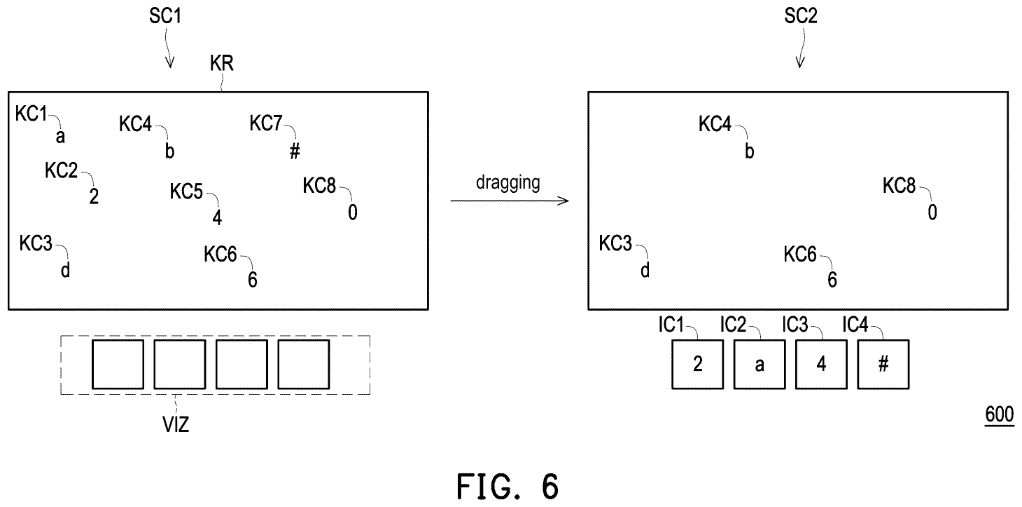

FIG. 6 is a schematic diagram of a secure login scenario according to an embodiment of the disclosure. With reference to FIG. 6, a secure login scenario 600 may include a first screen SC1 and a second screen SC2. At first, the first screen SC1 may be displayed in the virtual content VC. Then, after the user U performs some drag operations, the second screen SC2 may be displayed in the virtual content VC instead of the first screen SC1.

In one embodiment, the first screen SC1 may include the key relationship KR and a virtual input zone VIZ. The key relationship KR may include a plurality of key characters KC1˜KC8. As shown in FIG. 6, the plurality of key characters KC1˜KC8 may include alphabets, number, and special characters (e.g., “#”, “! ” . . . etc.). The virtual input zone VIZ may include some blanks and the user U may drag some of the plurality of key characters KC1˜KC8 into these blanks.

That is, in this embodiment, a plurality of key gestures KG1˜KG4 (not shown) may be defined as the gestures used to dragging some of the plurality of key characters KC1˜KC8 into the virtual input zone VIZ. Then, the characters in the virtual input zone VIZ may be determined as the input characters IC1˜IC4. In other words, the processor 104 may be configured to determine that whether a plurality of selected characters of the plurality of key characters KC1˜KC8 being dragged into the virtual input zone VIZ in the virtual world.

In one embodiment, after the plurality of selected characters are dragged into the virtual input zone VIZ, the second screen SC2 may be displayed in the virtual content VC instead of the first screen SC1. For example, the key characters KC1, KC2, KC5, KC7 may be dragged into the virtual input zone VIZ and then determined as the input characters IC1˜IC4. That is, in response to the plurality of selected characters of the plurality of key characters KC1˜KC8 being dragged into the virtual input zone VIZ in the virtual world, the processor 104 may be configured to determine the selected characters as the plurality of input characters IC1˜IC4. However, this disclosure is not limited thereto.

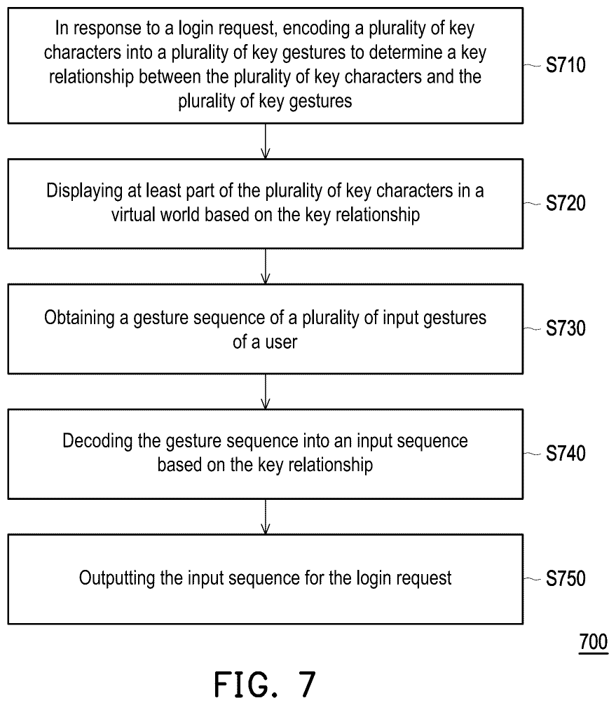

FIG. 7 is a schematic flowchart of a secure login method according to an embodiment of the disclosure. A secure login method 700 may include steps S710˜S750.

In the step S710, in response to a login request, the processor 104 may be configured to encode a plurality of key characters (e.g., KC1˜KC5 on FIG. 2A) into a plurality of key gestures (e.g., KG1˜KG5 on FIG. 2B) to determine a key relationship KR between the plurality of key characters KC1˜KC5 and the plurality of key gestures KG1˜KG5. In the step S720, the processor 104 may be configured to display at least part of the plurality of key characters KC1˜KC5 in a virtual world based on the key relationship KR. In the step S730, the processor 104 may be configured to obtain a gesture sequence GS of a plurality of input gestures (e.g., IG1˜IG4 on FIG. 2C) of a user U. In the step S740, the processor 104 may be configured to decode the gesture sequence GS into an input sequence IS based on the key relationship KR. In the step S750, the processor 104 may be configured to output the input sequence IS for the login request.

In addition, the implementation details of the secure login method 700 may be referred to the descriptions of FIG. 1 to FIG. 6 to obtain sufficient teachings, suggestions, and implementation embodiments, while the details are not redundantly described seriatim herein.

In summary, according to the host 100, the secure login system 190, and the secure login method 700, instead of relying on a fixed layout, a random layout may be provided each time when the user U intends to login. The random layout may include a plurality of gestures and a plurality of characters corresponding to the plurality of gestures. In this manner, even if people nearby see movements of the hand of the user U, they are still not able to obtain clues to the content being inputting by the user U. Therefore, the user U may enter confidential data conveniently and safely, thereby increasing the user experience.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A host, comprising:
a storage circuit, configured to store a program code; and
a processor, coupled to the storage circuit and configured to access the program code to execute:
in response to a login request, encoding a plurality of key characters into a plurality of key gestures to determine a key relationship between the plurality of key characters and the plurality of key gestures;
displaying at least part of the plurality of key characters in a virtual world based on the key relationship;
obtaining a gesture sequence of a plurality of input gestures of a user;
decoding the gesture sequence into an input sequence based on the key relationship; and
outputting the input sequence for the login request.

2. The host according to claim 1, wherein the processor is further configured to access the program code to execute:
encoding the plurality of key characters into the plurality of key gestures by randomly assigning the plurality of key characters to the plurality of key gestures.

3. The host according to claim 1, wherein the processor is further configured to access the program code to execute:
decoding the gesture sequence by decoding each of the input gestures of the gesture sequence to one of the plurality of key characters based on the key relationship.

4. The host according to claim 1, wherein
the input sequence comprises a plurality of input characters.

5. The host according to claim 1, wherein the processor is further configured to access the program code to execute:
performing a comparison of the input sequence with a password sequence; and
determining a login result of the login request based on the comparison.

6. The host according to claim 1, wherein the processor is further configured to access the program code to execute:
determining that whether one of the plurality of input gestures being a switch gesture; and
in response to the plurality of input gestures being the switch gesture, displaying a plurality of switched key characters in the virtual world based on the key relationship.

7. The host according to claim 1, wherein the processor is further configured to access the program code to execute:
obtaining a plurality of self-defined gestures of the user; and
determining the plurality of self-defined gestures as the plurality of key gestures.

8. The host according to claim 1, wherein the processor is further configured to access the program code to execute:
determining that whether a plurality of selected characters of the plurality of key characters being dragged into a virtual input zone in the virtual world; and
in response to the plurality of selected characters of the plurality of key characters being dragged into the virtual input zone in the virtual world, determining the selected characters as a plurality of input characters.

9. The host according to claim 1, wherein the plurality of key characters comprises alphabet, special characters and/or numbers.

10. The host according to claim 1, wherein the processor is further configured to access the program code to execute:
performing a hand tracking through a sensor; and
obtaining the gesture sequence of the plurality of input gestures of the user based on the hand tracking.

11. The host according to claim 1, wherein
the virtual world is displayed on a private display device and content displayed by the private display device is only visible to the user.

12. The host according to claim 11, wherein the private display device is comprised in a head-mounted device.

13. A secure login system, comprising:
a private display device, configured to display virtual content and the virtual content is only visible to a user;
a storage circuit, configured to store a program code; and
a processor, coupled to the private display device and the storage circuit and configured to access the program code to execute:
in response to a login request, encoding a plurality of key characters into a plurality of key gestures to determine a key relationship between the plurality of key characters and the plurality of key gestures;
displaying, through the private display device, at least part of the plurality of key characters in a virtual world based on the key relationship;
obtaining a gesture sequence of a plurality of input gestures of the user;
decoding the gesture sequence into an input sequence based on the key relationship; and
outputting the input sequence for the login request.

14. The secure login system according to claim 13, wherein the processor is further configured to access the program code to execute:
encoding the plurality of key characters into the plurality of key gestures by randomly assigning the plurality of key characters to the plurality of key gestures.

15. The secure login system according to claim 13, wherein the processor is further configured to access the program code to execute:
decoding the gesture sequence by decoding each of the input gestures of the gesture sequence to one of the plurality of key characters based on the key relationship.

16. The secure login system according to claim 13, wherein
the input sequence comprises a plurality of input characters.

17. The secure login system according to claim 13, wherein the processor is further configured to access the program code to execute:
performing a comparison of the input sequence with a password sequence; and
determining a login result of the login request based on the comparison.

18. The secure login system according to claim 13, wherein the processor is further configured to access the program code to execute:
determining that whether one of the plurality of input gestures being a switch gesture; and
in response to the plurality of input gestures being the switch gesture, displaying a plurality of switched key characters in the virtual world based on the key relationship.

19. The secure login system according to claim 13, wherein the processor is further configured to access the program code to execute:
obtaining a plurality of self-defined gestures of the user; and
determining the plurality of self-defined gestures as the plurality of key gestures.

20. A secure login method, comprising:
in response to a login request, encoding, through a processor, a plurality of key characters into a plurality of key gestures to determine a key relationship between the plurality of key characters and the plurality of key gestures;
displaying, through a private display device, at least part of the plurality of key characters in a virtual world based on the key relationship;
obtaining, through a sensor, a gesture sequence of a plurality of input gestures of a user;
decoding, through the processor, the gesture sequence into an input sequence based on the key relationship; and
outputting, through the processor, the input sequence for the login request.
